(19) United States
(12) Patent Application Publication
(10) Pub. No.: US 2009/0244320 A1
(43) Pub. Date: Oct. 1, 2009

(54) IMAGING DEVICE, DISPLAY CONTROL DEVICE, AND DISPLAY DEVICE

(76) Inventor: Daisuke Ito, Osaka (JP)

Correspondence Address: MCDERMOTT WILL & EMERY LLP, 600 13TH STREET, NW, WASHINGTON, DC, 20005-3096, US

(21) Appl. No.: 12/064,918

(22) PCT Filed: Aug. 14, 2006
(86) PCT No.: PCT/JP2006/316002

§ 371 Date: Feb. 26, 2008

(30) Foreign Application Priority Data
Aug. 26, 2005 (JP) 2005-246573

(51) Int. Cl. H04N 5/76; G06K 9/00

(52) U.S. Cl. 348/231.2; 382/165; 348/E05.031

(57) ABSTRACT

In the case of reduced display of a shot image, the shot image is displayed in accordance with an attitude of an imaging device at the time of shooting, whereby it is possible to attain an easily viewable and convenient reduced image display regardless of a shooting attitude, and to display a vertically shot image at a reduction ratio which enables sufficient viewability. A display section (55) displays an image in accordance with an image signal. An imaging optical system (L) forms an optical image of an object, and an imaging section (4) receives the optical image formed by the imaging optical system, and converts the optical image. into an electrical image signal. An attitude detection section (43) detects the attitude of the imaging device at the time of the shooting. A recording section (12) records the shot image and attitude information about the attitude of the imaging device. An image display control section (13) restores an orientation of the shot image so as to correspond to the attitude of the imaging device at the time of the shooting, clips a part of reduced image of the restored shot image, and causes the clipped image to be displayed on the display section.

### TECHNICAL FIELD

The present invention relates to a display method of an image shot by an imaging device, and more particularly to an imaging device, a display control device, and a display device which control a display method of a shot image in accordance with motion information of the imaging device.

### BACKGROUND ART

In recent years, an imaging sensor such as a CCD (Charge Coupled Device) and a CMOS (Complementary Metal-Oxide Semiconductor), and a signal processing circuit are increasingly improved in terms of integration density and come to be available inexpensively. Accordingly, by using such an imaging sensor and a processing device, a digital still camera and a digital video camera (hereinafter referred to as a “digital camera”), which are capable of converting an optical image of an object into an electrical image signal and outputting the same, are rapidly growing popular.

FIGS. 20A to 20C are diagrams each showing a relation between an attitude of the digital camera and an attitude of a shot image displayed on a display section thereof. As shown in FIGS. 20A to 20C, the photographer performs shooting while changing an attitude of a digital camera 100 in accordance with a shooting intention. For example, in the case of shooting a horizontally oriented object such as a landscape, the photographer turns the attitude of the digital camera 100 so as to be in a horizontally oriented state and then performs shooting. On the other hand, in the case of shooting a vertically oriented object such as a person and a building, the photographer turns the attitude of the digital camera 100 so as to be in a vertically oriented state and then performs shooting. Hereinafter, as shown in FIG. 20A, the attitude of the digital camera 100 when a stroke direction of a shutter button thereof is in parallel with the gravity direction is referred to as a horizontal shooting attitude. Further, as shown in FIG. 20B, the attitude of the digital camera 100 when the stroke direction of the shutter button is perpendicular to the gravity direction is referred to as a vertical shooting attitude. Further, an image shot in a horizontal shooting attitude is referred to as a horizontally shot image or a horizontal image, whereas an image shot in a vertically shooting attitude is referred to as a vertically shot image or a vertical image. In a conventional digital camera 100, a shot image is displayed in the same direction as the attitude of the digital camera 100 at the time of shooting. That is, in the case where an image shot in the vertical shooting attitude, as shown in FIG. 20B, is displayed on the display section while the digital camera 100 is in the horizontal attitude, as shown in FIG. 20C, an orientation of a shot image to be displayed thereon is different from an orientation at the time of the shooting. Therefore, in the case of displaying a series of shot images in which vertically shot images and horizontally shot image are mixed together, a problem of difficulty in viewing is caused since the orientation of the vertically shot images are different from the orientation at the time of the shooting.

Against the problem, a technique is proposed, which provides the imaging device having rotating state detection means which detects a rotation state of photoelectric conversion means, and adding means which adds rotation state information at the time of the shooting to image information obtained based on an output from the photoelectric conversion means (Patent Document 1).

The rotating state information is added to a shot image signal, whereby it is possible to detect a shooting attitude of the digital camera at the time of the shooting, and to perform a display corresponding to the attitude at the time of the shooting regardless of the shot image either in the horizontally shot attitude or in the vertically shot attitude.

### Patent Document 1: Japanese Laid-Open Patent Publication No. 2001-45354

### DISCLOSURE OF THE INVENTION

### Problems to be Solved by the Invention

In the case where a photographer displays a plurality of shot images, there is a method for displaying a list of the shot images on a display section 200 provided in a digital camera. In order to be displayed as the list, each of the shot images is reduced and then displayed. Hereinafter, to display a list of a plurality of images on the display section is referred to as a thumbnail display, and images which are reduced so as to be displayed as the list are each referred to as a thumbnail image. Further, a thumbnail image of an image which is shot in a horizontal shooting attitude is referred to as a horizontal thumbnail image, and a thumbnail image of an image which is shot in a vertical shooting attitude is referred to as a vertical thumbnail image.

As shown in FIG. 21, according to an invention described in Patent Document 1, in the case where the shot images are displayed in a thumbnail form, display in accordance with an attitude at the time of shooting can be performed regardless of the horizontally shot image or the vertically shot image. However, the vertical thumbnail image displayed on the display section 200 is displayed narrowly in the horizontal direction compared with the horizontal thumbnail image, and cannot be displayed in an enlarged manner. Therefore, the vertical thumbnail image displayed on the display section 200 is displayed in a small size compared with a size of the horizontal thumbnail image, which causes a problem in that the photographer has difficulty in viewing, and also causes a problem of poor viewability.

Therefore, an object of the present invention is to provide an imaging device, a display control device, and a display device which display, in the case of displaying the shot images in a reduced manner, the shot images in accordance with an attitude of the imaging device at the time of shooting, and enable easily viewable and convenient reduced image display regardless of a shooting attitude.

Further, another object of the present invention is to provide an imaging device, a display control device, and a display device which display, in the case of displaying the shot images in the reduced manner, the vertically shot images at a reduction ratio which allows sufficient viewability, and then enable easily viewable and convenient reduced image display.

### Solution to the Problems

Objects of the present invention are attained by an imaging device having the following configurations. An imaging device is operable to output an optical image of an object as an electrical image signal, and comprises:
a display section for displaying an image in accordance with the image signal;
an imaging optical system for forming the optical image of the object;
an imaging section for receiving the optical image formed by the imaging optical system and converting the optical image into the electrical image signal;
an attitude detection section for detecting an attitude of the imaging device at the time of shooting;
a recording section for recording a shot image obtained by the imaging section, and attitude information about the attitude of the imaging device, the attitude being detected by the attitude detection section and corresponding to the shot image; and
an image display control section for restoring the shot image, in accordance with the attitude information, such that an orientation thereof corresponds to the attitude of the imaging device at the time of the shooting, clipping a portion of a reduced image of the restored shot image, and displaying the clipped image on the display section.

The objects of the present invention are attained by an imaging device having the following configuration. An imaging device is operable to output an optical image of an object as an electrical image signal, the optical image being formed by an exchangeable imaging optical system, and comprises:
a display section for displaying an image in accordance with the image signal;
an imaging section for receiving the optical image formed by the imaging optical system which is mounted, and converting the optical image into the electrical image signal;
an attitude detection section for detecting an attitude of the imaging device at the time of shooting;
a recording section for recording a shot image obtained by the imaging section, and attitude information about the attitude of the imaging device, the attitude being detected by the attitude detection section and corresponding to the shot image; and
an image display control section for restoring the shot image, in accordance with the attitude information, such that an orientation thereof corresponds to the attitude of the imaging device at the time of the shooting, clipping a portion of a reduced image of the restored shot image, and displaying the clipped image on the display section.

The objects of the present invention are attained by an imaging device having the following configuration. An imaging device is operable to output an optical image of an object as an electrical image signal and to be connected to a display section, and comprises:
an imaging optical system for forming the optical image of the object;
an imaging section for receiving the optical image formed by the imaging optical system and converting the optical image into the electrical image signal;
an attitude detection section for detecting an attitude of the imaging device at the time of shooting;
a recording section for recording a shot image obtained by the imaging section, and attitude information about the attitude of the imaging device, the attitude being detected by the attitude detection section and corresponding to the shot image;
an image display control section for generating a control signal which controls a display of the shot image recorded in the recording section; and
an output section for providing the generated control signal and the shot image to the display section, wherein
the control signal includes a signal which causes the shot image to be restored in accordance with the attitude information such that an orientation thereof corresponds to the attitude of the imaging device at the time of the shooting, causes a portion of a reduced image of the restored shot image to be clipped, and causes the clipped image to be displayed on the display section.

The objects of the present invention are attained by a display control device having the following configuration. A display control device is connectable to a display section, and comprises:
a reading section for reading a shot image and attitude information which are recorded in a recording section, the attitude information indicating an attitude of an imaging device and corresponding to the shot image;
an image display control section for generating a control signal causing a reduced image of the shot image to be displayed; and
an output section for providing the shot image and the attitude information, which have been read, to the display section, wherein
the control signal includes a signal which causes the shot image to be restored in accordance with the attitude information such that an orientation thereof corresponds to the attitude of the imaging device at the time of shooting, causes a portion of a reduced image of the restored shot image to be clipped, and causes the clipped image to be displayed on the display section.

### EFFECT OF THE INVENTION

According to the present invention, it is impossible to provide an imaging device, a display control device and a display device which perform displaying, in the case of displaying the shot images in the reduced manner, in accordance with the attitude of the imaging device at the time of shooting, and then enable a convenient reduced image display regardless of a shooting attitude.

Further, according to the present invention, it is possible to provide the imaging device, the display control device and the display device which display, in the case of displaying the shot images in the reduced manner, the vertically shot images at a reduction ratio which allows sufficient viewability, and then enable the convenient reduced image display.

### BRIEF DESCRIPTION OF THE DRAWINGS

FIG. 1 is a block diagram showing a control system of a digital camera according to embodiment 1.

FIG. 2A is a top view of the digital camera according to embodiment 1.

FIG. 2B is a back view of the digital camera according to embodiment 1.

FIG. 3 is a diagram showing an attitude determination signals corresponding to respective shooting attitudes according to embodiment 1.

FIG. 4 is a diagram illustrating a managing method of shot image files according to embodiment 1.

FIG. 5 is a flowchart, from a start of recording to an end of recording, showing a recording method of a shot image according to embodiment 1.

FIG. 6 is a diagram showing a vertical image display region selection menu which is displayed on a display section according to embodiment 1.

FIG. 7A is an example of a display of an image shot in a horizontal shooting attitude in embodiment 1.

FIG. 7B is another example of a display of an image shot in a vertical shooting attitude in embodiment 1.

FIG. 8A is a diagram showing a display state of the display section in the case where an upper region selection button is selected from the vertical image display region selection menu included in embodiment 1.

FIG. 8B is a diagram showing another display state of the display section in the case where a central region selection button is selected from the vertical image display region selection menu included in embodiment 1.

FIG. 8C is a diagram showing another display state of the display section in the case where a lower region selection button is selected from the vertical image display region selection menu included in embodiment 1.

FIG. 9A is an example of a thumbnail display in the case where a whole region selection button is selected from the vertical image display region selection menu included in embodiment 1.

FIG. 9B is another example of the thumbnail display in the case where the upper region selection button is selected from the vertical image display region selection menu.

FIG. 10 is a diagram showing an example of a display of a vertical/horizontal image selection menu according to embodiment 1.

FIG. 11A is an example of the thumbnail display on the display section included in embodiment 1.

FIG. 11B is another example of the thumbnail display on the display section included in embodiment 1.

FIG. 11C is another example of the thumbnail display on the display section included in embodiment 1.

FIG. 12A is an example of a display of a vertical image display region selection menu on a display section included in embodiment 2.

FIG. 12B is an example of a display of a specific color selection menu on the display section included in embodiment 2.

FIG. 13A is a diagram showing a vertically shot image displayed on the display section according to embodiment 2.

FIG. 13B is a diagram showing another vertically shot image displayed on the display section according to embodiment 2.

FIG. 14A is a diagram showing another vertically shot image displayed on the display section according to embodiment 2.

FIG. 14B is a diagram showing another vertically shot image displayed on the display section according to embodiment 2.

FIG. 14C is a diagram showing another vertically shot image displayed on the display section according to embodiment 2.

FIG. 15A is a diagram showing a shot image displayed on a display section according to embodiment 3.

FIG. 15B is a diagram showing another shot image displayed on the display section according to embodiment 3.

FIG. 16A is a diagram showing an enlargement ratio of a vertically shot image displayed on the display section according to embodiment 3.

FIG. 16B is a diagram showing another enlargement ratio of the vertically shot image displayed on the display section according to embodiment 3.

FIG. 17A is a diagram showing a mode setting section according to embodiment 4.

FIG. 17B is a diagram showing another mode setting section according to embodiment 4.

FIG. 18 is a diagram showing an imaging device and a display device according to embodiment 5.

FIG. 19 is a diagram showing an imaging device and a display device according to embodiment 6.

FIG. 20A is a diagram showing a relation between an attitude of a digital camera and an attitude of a shot image displayed on a display section.

FIG. 20B is a diagram showing another relation between the attitude of the digital camera and the attitude of the shot image displayed on the display section.

FIG. 20C is a diagram showing another relation between the attitude of the digital camera and the attitude of the shot image displayed on the display section.

FIG. 21 is a diagram showing a display section in the case of a thumbnail display.

### DESCRIPTION OF THE REFERENCE CHARACTERS

1 digital camera
1a housing
2 lens
3 microcomputer
3A signal processing section
4 imaging sensor
5 CCD drive control section
6 analog signal processing section
7 A/D conversion section
8 digital signal processing section
9 buffer memory
10 image compressing section
11 image recording control section
12 image recording section
13 image display control section
35 power switch
36 shutter operation section
37 shooting/reproduction switching operation section
37b shooting/reproduction switching operation section
38 cross operation key
39 MENU setting operation section
40 SET operation section
41 shutter control section
42 shutter drive motor
43 attitude detection section
50 internal memory
51 removable memory
55 display section
57 zoom operation section
60 attitude determination signal
61 scene mode selection menu
65 vertical/horizontal image selection menu
66 vertical image display region selection menu
67 vertical image display region selection menu
70 display device
75 cable
80 display device
81 removable memory insertion section
82 display control device
90 shot image folder
91 still image folder
92 moving image folder
93 horizontal attitude image folder
94 vertical attitude image folder
95 still image file
96 moving image file
L imaging optical system
L1 first lens unit
L2 second lens unit
L3 third lens unit

### BEST MODE FOR CARRYING OUT THE INVENTION

### Embodiment 1

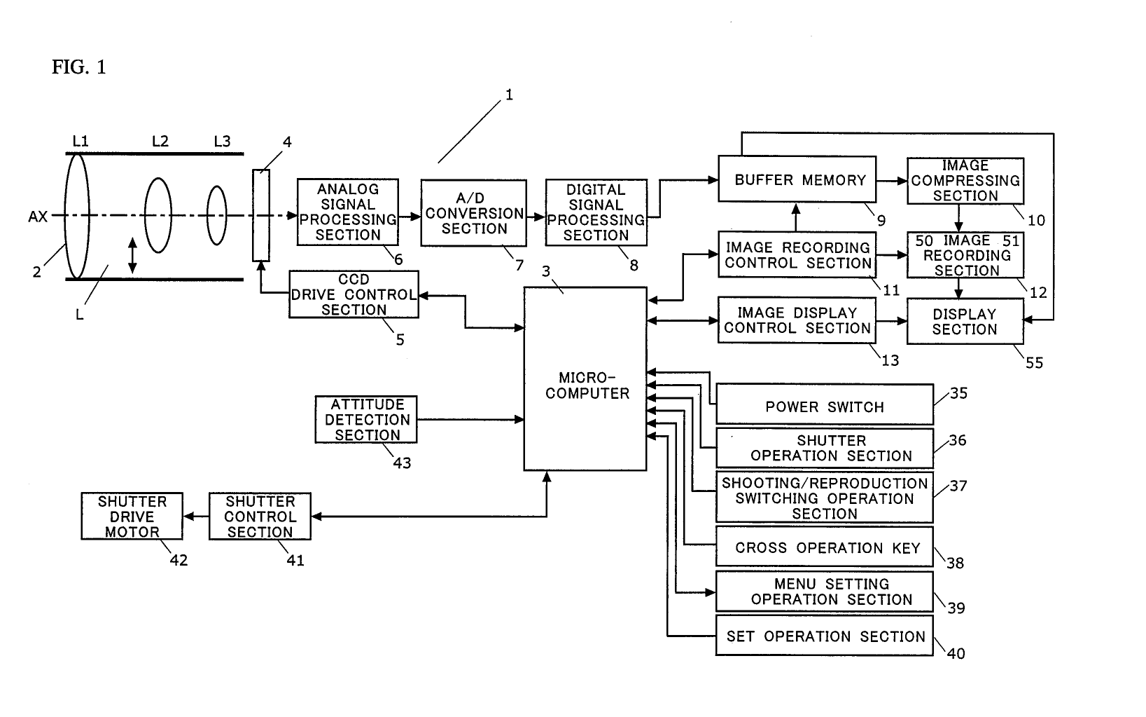

FIG. 1 is a block diagram showing a general configuration of a digital camera 1 according to embodiment 1 of the present invention. As shown in FIG. 1, the digital camera 1 includes an imaging optical system L, a microcomputer 3, an imaging sensor 4, a CCD drive control section 5, an analog signal processing section 6, an A/D conversion section 7, a digital signal processing section 8, a buffer memory 9, an image compressing section 10, an image recording control section 11, an image recording section 12, an image display control section 13, a display section 55, a shutter control section 41 and a shutter drive motor 42.

The imaging optical system L is an optical system including three les units L1, L2 and L3. The first lens unit L1 moves in an optical axis direction, whereby focusing is performed, and the third lens unit L3 moves in the optical axis direction, whereby zooming is performed. The second lens unit L2 is a compensation lens unit, and plays a role of compensating a motion of an image by moving on a plane perpendicular to the optical axis and by decentering the optical axis.

When a mechanical vibration or a jiggle caused by a photographer is applied to the digital camera 1, an optical axis of light which contributes to forming an object image, among light emitted from an object to a lens, is misaligned with an optical axis of the lens. Therefore, an image obtained in such a case is a blurred image. A preventive mechanism provided against this is called, hereinafter, an image blurring compensation mechanism.

The microcomputer 3 controls the whole of various control sections of the digital camera 1. Further, the microcomputer 3 is capable of receiving respective signals from a power switch 35, a shutter operation section 36, a shooting/reproduction switching operation section 37, a cross operation key 38, a MENU setting operation section 39, and a SET operation section 40.

In response to a timing signal generated by an operation of the shutter operation section 36, the shutter control section 41 drives the shutter drive motor 42 in accordance with a control signal from the microcomputer 3, and then actuates a shutter.

The imaging sensor 4 is a CCD, and converts an optical image formed by an imaging optical system L into an electrical signal. The imaging sensor 4 is drive-controlled by the CCD drive control section 5. The imaging sensor 4 may be a CMOS.

An image signal outputted by the imaging sensor 4 is transmitted and processed through the analog signal processing section 6, the A/D conversion section 7, the digital signal processing section 8, the buffer memory 9, and the image compressing section 10, in sequence. In the analog signal processing section 6, the image signal outputted by the imaging sensor 4 is subject to analog signal processing such as gamma processing. The A/D conversion section 7 converts an analog signal outputted by the analog signal processing section 6 into a digital signal. In the digital signal processing section 8, the image signal, which is the digital signal converted by the A/D conversion section 7, is subject to digital signal processing such as noise reduction and edge enhancement. The buffer memory 9 is a RAM (Random Access Memory), and temporarily stores the image signal processed by the digital signal processing section 8.

Further, the image signal stored in the buffer memory 9 is transmitted and processed through the image compressing section 10 to the image recording section 12, in sequence. The image signal stored in the buffer memory 9 is read in accordance with a command issued by the image recording control section 11, and transmitted to the image compressing section 10. Data of the image signal is, thereafter, compressed to a predetermined size. In this case, the image signal is compressed at a predetermined rate, and thus the data size is decreased. As a compressing method, a JPEG (Joint Photographic Experts Group) method may be adopted, for example. At the same time, the image compressing section 10 also creates a reduced image signal which corresponds to a shot image and is used for thumbnail display or the like. Then, the compressed image signal and the reduced image signal are transmitted to the image recording section 12.

The image recording section 12 further includes an internal memory 50 and/or a removable memory 51, and in accordance with a command issued by the image recording control section 11, interrelates and records the image signal, the reduced image signal corresponding thereto, and a predetermined information to be recorded. The predetermined information to be recorded together with the image signal includes a date when an image was shot, focal length information, shutter speed information, aperture value information, shooting mode information, and an attitude of the digital camera 1 which is described later.

The image display control section 13 is controlled by a control signal from the microcomputer 3. In accordance with a command from the image display control section 13, the display section 55 displays the image signal recorded in the image recording section 12 or the buffer memory 9 as a visible image. As display modes, the display section 55 has a mode for display only an image signal, and a mode for displaying information at the time of shooting of the image signal. The information at the time of the shooting of the image signal includes the focal length information, the shutter speed information, the aperture value information, the shooting mode information, focusing state information, and the attitude information. These pieces of information are displayed by operating the MENU setting operation section 39.

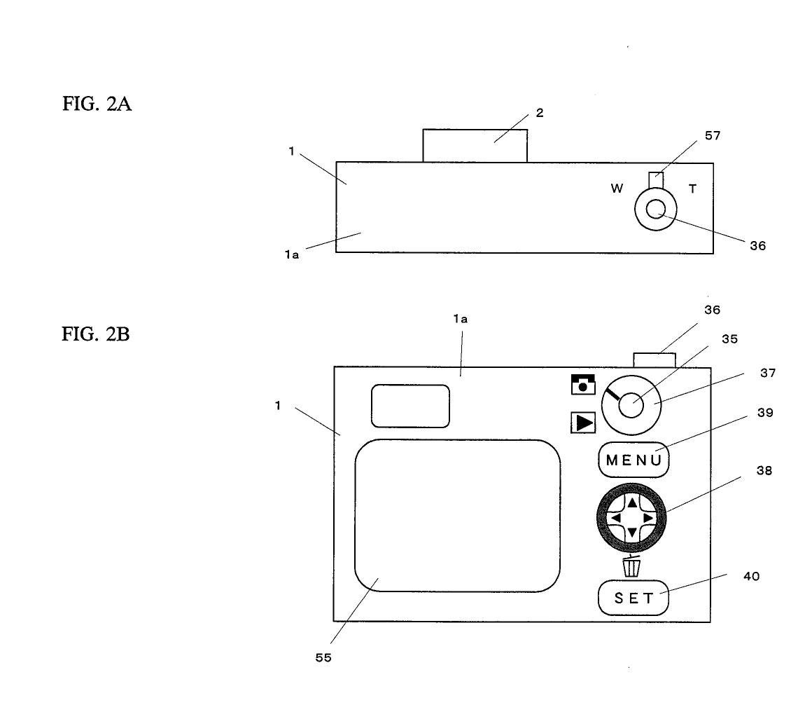

Next, a configuration of the digital camera 1 according to embodiment 1 will be described, with reference to FIG. 2. FIG. 2A is a top view of the digital camera 1, and FIG. 2B is a back view of the digital camera 1.

A housing 1a has an imaging optical system including a lens 2 situated on a front surface thereof, and also has situated on a back surface thereof the power switch 35, the shooting/reproduction switching operation section 37, the cross operation key 38, the MENU setting operation section 39, the SET operation section 40, and the display section 55 which is constituted of an LCD monitor with an aspect ratio of 4:3. Further, the housing 1a has situated on the top surface thereof the shutter operation section 36 and the zoom operation section 57.

The zoom operation section 57 is rotatably located in the vicinity of the shutter operation section 36 so as to be coaxial with the shutter operation section 36. The power switch 35 is an operation member for turning the power of the digital camera 1 ON/OFF. The shooting/reproduction switching operation section 37 is an operation member for switching between a shooting mode and a reproducing mode, and every time a lever thereof is rotated, switching is performed. Under the condition that the shooting mode is selected, the microcomputer 3 controls the imaging optical system L so as to be telephoto when the zoom operation section 57 is rotated to the right direction, and so as to be wide-angle when the same is rotated to the left direction. The MENU setting operation section 39 is an operation member for causing various menus to be displayed on the display section 55. The cross operation key 38 is an operation member for selecting, based on the operation of the MENU setting operation section 39, a desired menu from among the various operation menus displayed on the display section 55, and has selection buttons respectively situated at upper, lower, right and left portions thereof. When any one of the various operation menus is selected in accordance with the operation of the cross operation key 38, the microcomputer 3 issues a command for executing an operation of the selected menu. The SET operation section 40 is an operation member for returning the display of the various operation menus to a state prior to such display.

Next, an attitude detection section 43 for detecting the attitude of the digital camera 1 according to the present embodiment will be described. Presently, various types of attitude detection sections are available in the world. As an exemplary type, there is such a type that has a rotation detection device mounted thereto as disclosed in Patent Document 1. Alternatively, a digital camera may have an image blurring compensation device, which detects vibration applied to the imaging device and drives the compensation lens of the imaging optical system in two direction respectively perpendicular to the optical axis, and determines an attitude of the imaging device by detecting a signal for driving the compensation lens. Any of these types of the attitude detection sections may be provided, or without limiting to this, an angular velocity sensor or the like may be fixed to the digital camera. In other words, any configuration for detecting the attitude is applicable irrespective of its detecting method.

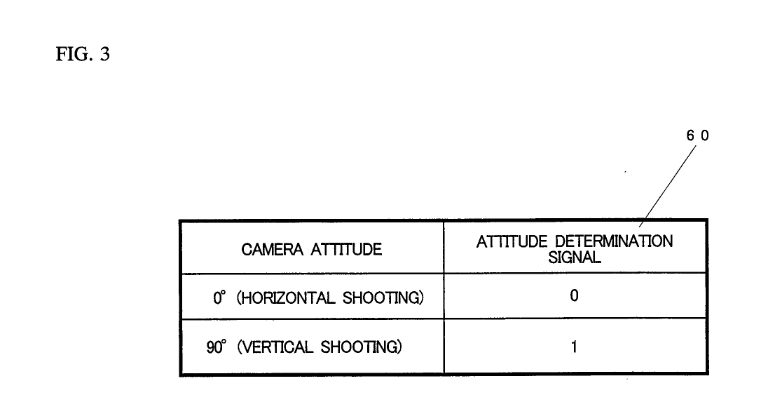

Next, with reference to FIG. 3, an operation of the digital camera 1 according to the present embodiment will be described. Here, the attitude of the digital camera 1 in a horizontal shooting attitude is set as a reference, and an angle at this time is set as 0 degree. The attitude of the digital camera 1 in a vertical shooting attitude is a state of an attitude which is rotated about the optical axis by 90 degrees from the horizontal shooting attitude.

FIG. 3 is a diagram showing attitude determination signals corresponding to respective shooting attitudes. In the case of shooting, the photographer turns the power switch 35 ON, and turns the shooting/reproduction switching operation section 37 to the shooting mode. Accordingly, the digital camera 1 is shifted to a shootable state.

A case will be described where the photographer shoots, in the horizontal shooting attitude, a horizontal object such as a landscape. Based on a value outputted from the attitude detection section 43, the microcomputer 3 determines that the attitude of the digital camera 1 is the horizontal shooting attitude. In this state, the photographer presses the shutter operation section 36, thereby shooting the object. Here, the aspect ratio of an image shot in the horizontal shooting attitude is 4:3. The shot image is recorded in the image recording section 12. In this case, as shown in FIG. 3, the image recording control section 11 adds an attitude determination signal 60 (0), which indicates that the shooting attitude of the digital camera 1 is 0 degree, to the image signal outputted from the buffer memory 9. The attitude determination signal 60 is, for example, recorded in a header or a footer portion of the image signal. As a site in which the attitude determination signal 60 is recorded, either of the buffer memory 9 or the image recording section 12 may be applicable.

On the other hand, in the case where the photographer shoots, in the vertical shooting attitude, a vertically oriented object such as a person, the microcomputer 3 determines from the value outputted from the attitude detection section 43 that the attitude of the digital camera 1 is the vertical shooting attitude, in the same manner as the horizontal shooting attitude. In this state, the photographer presses the shutter operation section 36, thereby shooting the object. Here, the aspect ratio of the image shot in the vertical shooting attitude is 3:4. The shot image is recorded in the image recording section 12. In this case, the image recording control section 11 adds, to the image signal outputted from the buffer memory 9, an attitude determination signal 60 (1) which indicates that the shooting attitude of the digital camera 1 is the vertical shooting attitude which is rotated about the optical axis by 90 degrees from the horizontal shooting attitude.

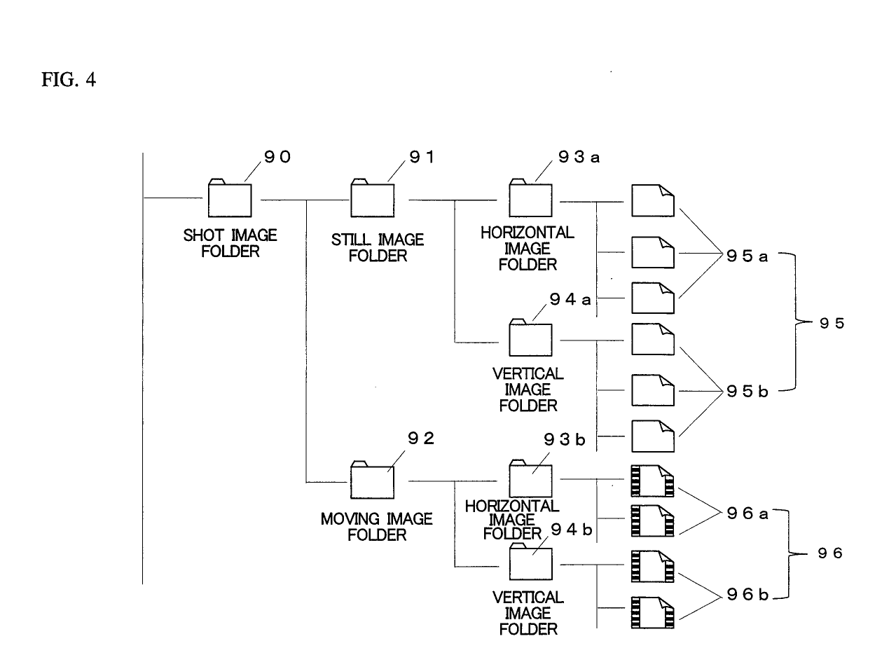

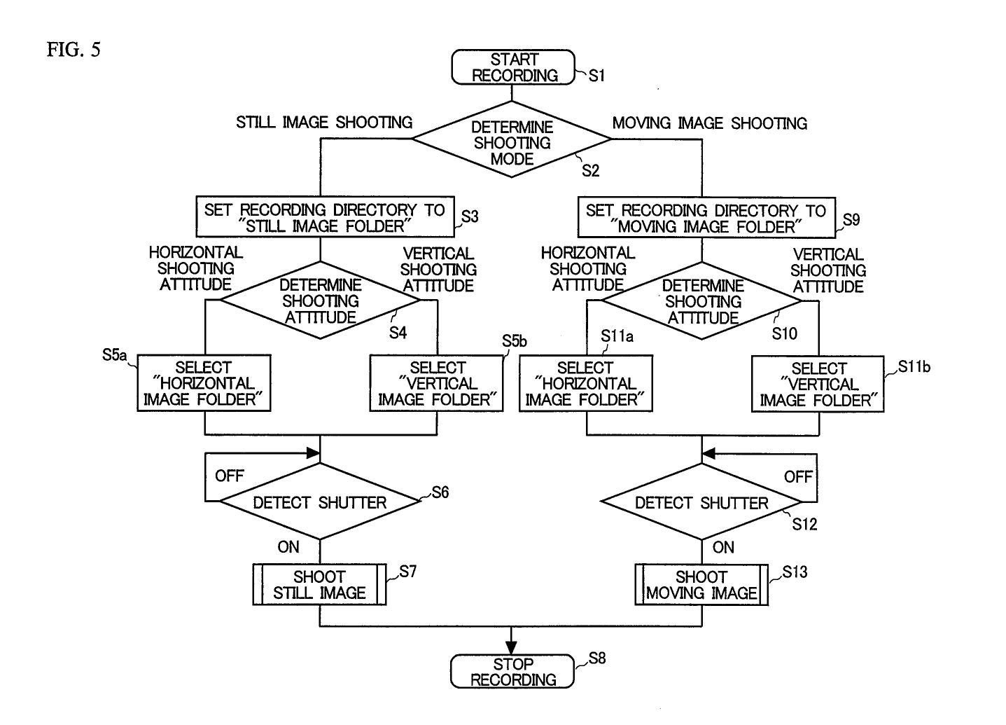

Next, with reference to FIGS. 4 and 5, a managing method of a shot image file will be described. As shown in FIG. 4, in the internal memory 50 or the removable memory 51, created are a shot image folder 90, and a still image folder 91 and a moving image folder 92, respectively in a hierarchy thereunder. Further, in hierarchies under the still image folder 91 and the moving image folder 92, horizontal attitude image folders 93a and 93b, and vertical attitude image folders 94a and 94b are created, respectively. Therefore, the shot images are divided into respective folders either for still images or for moving images, and further, stored in accordance with the shooting attitude at the time of shooting. The still images shot in a still image shooting mode are stored, as a still image file 95, either in the horizontal attitude image folder 93a or in the vertical attitude image folder 94a. On the other hand, moving images shot in a moving image shooting mode are stored, as a moving image file 96, either in the horizontal attitude image folder 93b or in the vertical attitude image folder 94b.

FIG. 5 is a flowchart, from a start of recording to an end of recording, showing a recording method of the shot image. The photographer presses the MENU setting operation section 39 in order to record the shot image, and causes a various menu screen to be displayed on the display section 55. From the displayed various menu screen, image recording is selected. Accordingly, the digital camera 1 is shifted to an image recording mode (step S1) Next, the microcomputer 3 determines the shooting mode. In other words, the microcomputer 3 determines whether the photographer has selected the still image shooting mode or the moving image shooting mode (step S2).

In the case where the photographer selects the still image shooting mode, the microcomputer 3 sets the still image folder 91 as a recording directory of the shot image (step S3) The attitude of the digital camera 1 is then determined by the attitude detection section 43 (step S4) Further, as a storage folder of the shot image, the horizontal attitude image folder 93a is set in the case of shooting in the horizontal shooting attitude, whereas the vertical attitude image folder 94a is set in the case of shooting in the vertical shooting attitude (steps S5a and S5b). Next, pressing of the shutter operation section 36 by the photographer is waited for (step S6), and in the case where the same is pressed, still image shooting is performed (step S7), and recording ends thereafter (step S8). In this case, the shot still image is stored, as the image file 95a or 95b, in the horizontal attitude image folder 93a or the vertical attitude image folder 94a.

On the other hand, in the case where the photographer selects the moving image shooting mode, the microcomputer 3 sets the moving image folder 92 as a recording directory of the shot image (step S9). The attitude of the digital camera 1 is then determined by the attitude detection section 43 (step S10) Further, as the storage folder of the shot image, the horizontal attitude image folder 93b is set in the case of shooting in the horizontal shooting attitude, whereas the vertical attitude image folder 94b is set in the case of shooting in the vertical shooting attitude (Step 10). Next, the pressing of the shutter operation section 36 is waited for (Step 12), and in the case where the same is pressed, the moving image shooting is performed (Step 13), and recording ends thereafter (Step 8). In this case, the shot moving image is stored, as the image file 96a or 96b, in the horizontal attitude image folder 93b or the vertical attitude image folder 94b.

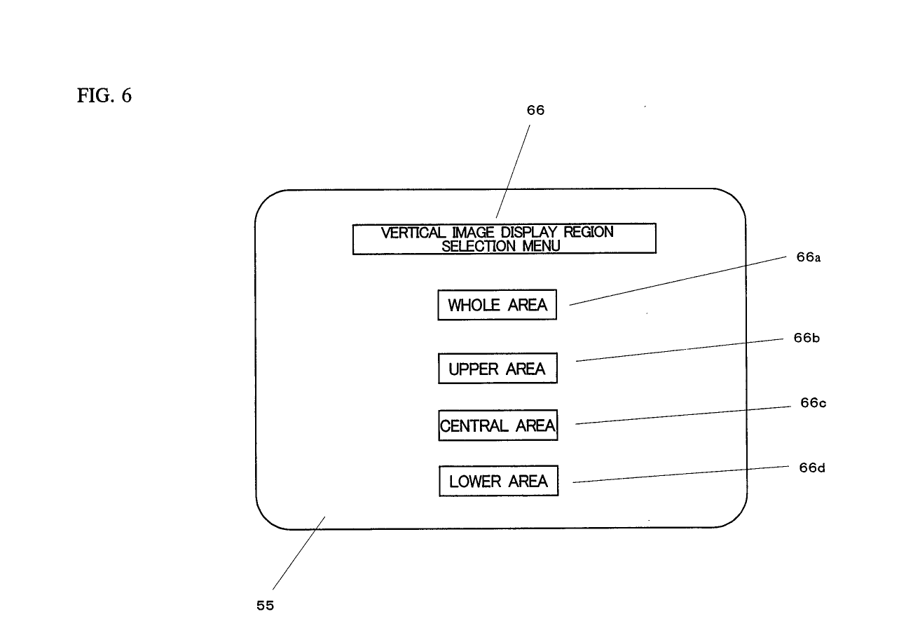

Next, a display process of the shot image will be described. FIG. 6 shows a vertical image display region selection menu 66 displayed on the display section 55. The vertical image display region selection menu 66 is constituted of region selection buttons, i.e., a whole region selection button 66a, an upper region selection button 66b, a central region selection button 66c, and a lower region selection button 66d. By pressing any one of the region selection buttons, the photographer can previously select a region to be displayed from the whole region of a vertical image.

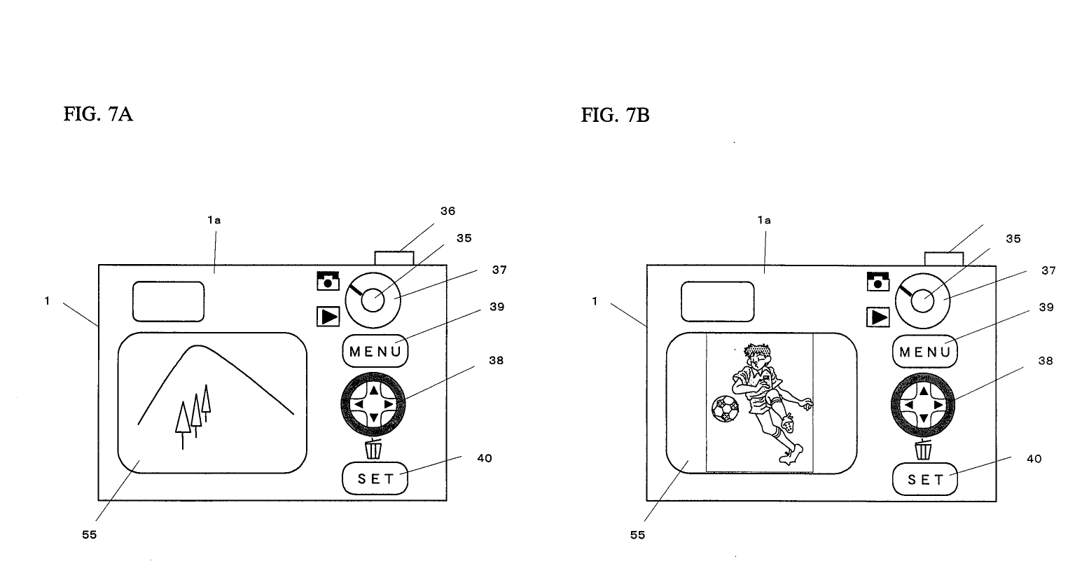

First, the photographer turns the power switch 35 ON so as to cause shot images to be displayed on the display section 55, and turns the shooting/reproduction switching operation section 37 to the reproduction mode. Accordingly, the shot images are displayed on the display section 55 in a thumbnail form. The photographer then operates the cross operation key 38 and selects an image from among images displayed in the thumbnail form. In accordance with the above-described operation, one shot image can be displayed on the display section 55. In this case, the image display control section 13 controls an image to be displayed in accordance with the attitude determination signal 60, which is recorded at the time of shooting, and information relating to a display region which is selected from the vertical image display region selection menu 66. Here, to the image shot in the horizontal shooting attitude, the attitude determination signal 60 (0) indicative of the horizontal shooting attitude is added at the time of the shooting. Therefore, as shown in FIG. 7A, the image display control section 13 restores and causes the shot image to be displayed on the display section 55 such that the attitude thereof is identical to the attitude at the time of the shooting.

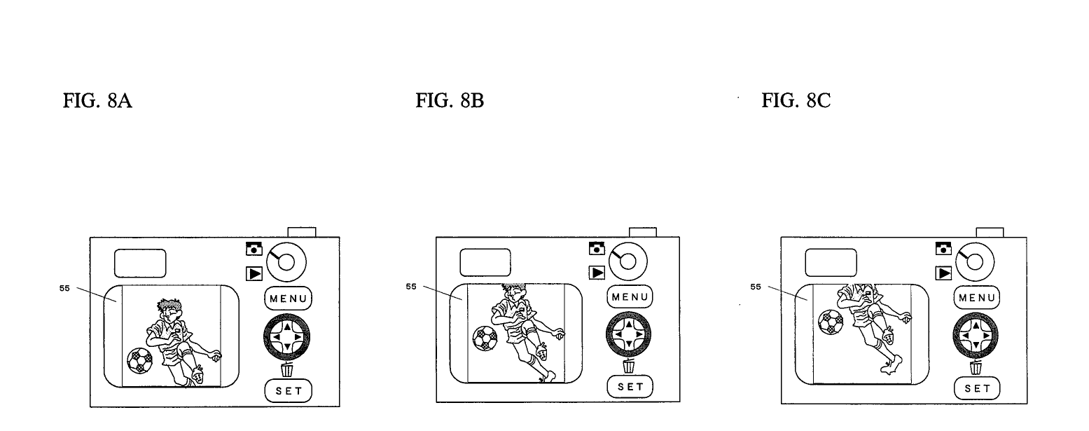

On the other hand, to the image shot in the vertical shooting attitude, the attitude determination signal 60 (1) indicative of the vertical shooting attitude is added at the time of the shooting. Therefore, as shown in FIG. 7B, the image display control section 13 restores and causes the shot image to be displayed on the display section 55 such that the attitude thereof is rotated by 90 degrees, that is, the attitude is identical to that at the time of the shooting. Here, the image display control section 13 causes an image to be displayed, the image having the display region which is selected from the vertical image display region selection menu 66. For example, in the case where the whole region selection button 66a is selected from the vertical image display region selection menu 66, the image display control section 13 causes the whole region of the vertically shot image to be displayed on the display section 55. In the case where the upper region selection button 66b is selected from the vertical image display region selection menu 66, the image display control section 13 causes an upper region of the shot image to be displayed. In a similar manner, in the case where the central region selection button 66c and the lower region selection button 66d are selected, the image display control section 13 causes a central region and a lower region of the shot image to be displayed, respectively. FIGS. 8A, 8B, and 8C each shows a display state of the display section 55 in the case where each of the upper region, the central region and the lower region selection buttons is selected from the vertical image display region selection menu 66. As shown in FIG. 7B, in the case of a whole region display on the display section 55, the vertically shot image is displayed in a reduced manner compared with a case where the horizontally shot image is displayed (FIG. 7A). Therefore, only a region, among the whole region, of the vertical image is selected from the vertical image display region selection menu 66 and then displayed, whereby it is possible to display the vertical image in an enlarged manner compared with a case of displaying the whole region of the vertical image. Therefore, even in the case of the vertically shot image, in the same manner as the horizontally shot image, it is possible to perform a convenient reduced image display which enables easy image recognition.

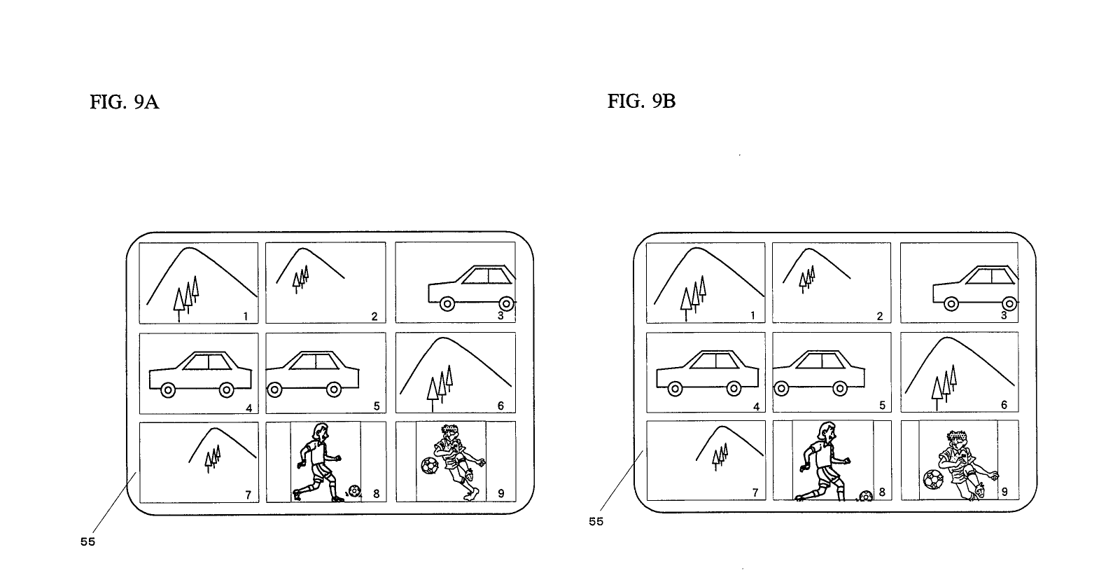

Next, a display process of the thumbnail image will be described. FIGS. 9A and 9B each shows an example of a display of the display section 55 on which horizontal thumbnail images and vertical thumbnail images are displayed in a mixed manner. On the display section 55, a list of nine thumbnail images, number 1 to number 9, are displayed. Seven thumbnail images, number 1 to number 7 are each a horizontal thumbnail image, and two thumbnail images, number 8 and number 9 are each a vertical thumbnail image. The horizontally shot images are each recorded while having added thereto the attitude determination signal 60 (0) which indicates that the shooting attitude thereof is rotated about the optical axis by 0 degree with respect to the horizontal shooting attitude. Therefore, the horizontal thumbnail images are each displayed in a state of the horizontal shooting attitude in accordance with the attitude determination signal 60 (0). On the other hand, the number 8 and number 9, i.e., the vertical thumbnail images are each recorded while having added thereto the attitude determination signal 60 (1) which indicates that the shooting attitude thereof is rotated about the optical axis by 90 degrees with respect to the horizontal shooting attitude. Therefore, as the vertical thumbnail images, images which are each rotated about the optical axis by 90 degrees with respect to the horizontal thumbnail image, in accordance with the attitude determination signal 60 (1), and which each corresponds to a region selected from the vertical image display region selection menu 66 are displayed. Here, in the case where any of the region selection buttons other than the whole region selection button is selected, images each corresponding to the selected region, among the whole region of the vertical image, are displayed on the display section 55 in an enlarged manner. FIG. 9A shows an example of the thumbnail display in the case where the whole region selection button 66a is selected from the vertical image display region selection menu 66. On the other hand, FIG. 9B shows an example of the thumbnail display in the case where the upper region selection button 66b is selected. As shown in FIG. 9B, each of the vertical thumbnail images, among the thumbnail images, shows an image of the region selected from the whole region of the vertical image in an enlarged manner, whereby viewability thereof is superior to a case of displaying the whole region of the vertical image. Therefore, even in the case of the vertically shot images, in the same manner as the horizontally shot images, it is possible to perform a convenient thumbnail display which enables the easy image recognition. Note that the photographer can enlarge and display the shot images one by one by operating the cross operation key 38 and selecting each of the thumbnail images.

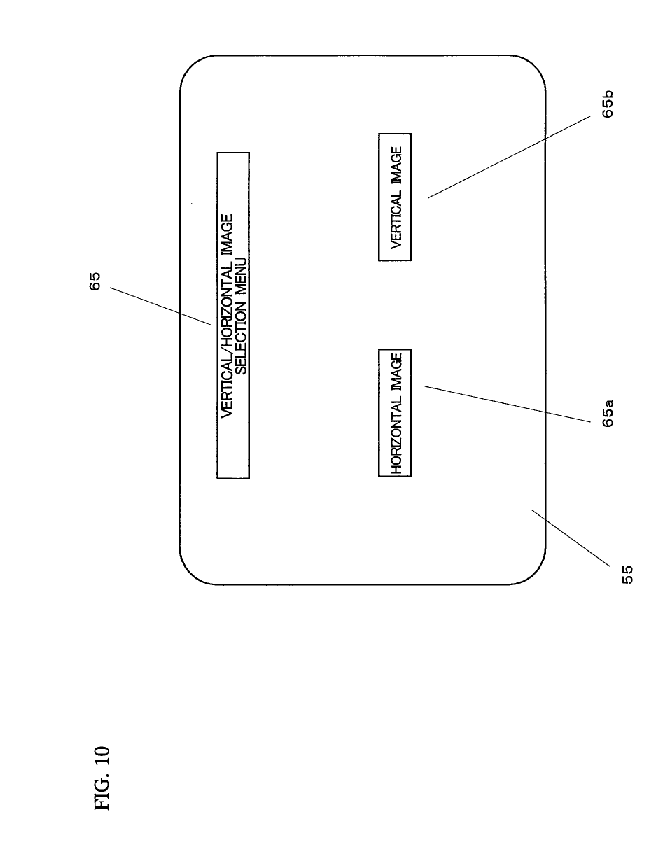

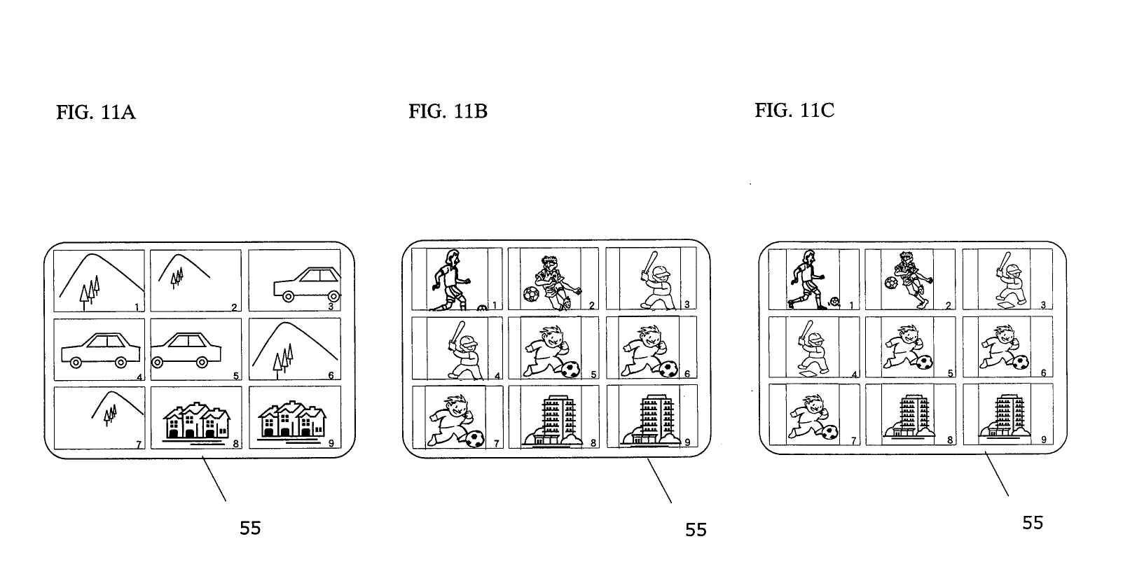

Next, a display process in the case where only the horizontally shot images or only the vertically shot images are displayed, in the thumbnail form, on the display section 55 will be described. FIG. 10 shows a vertical/horizontal image selection menu displayed on the display section 55, an FIGS. 11A to 11C show examples of the display of the display section 55 in the case where only the horizontally shot images or only the vertically shot images are displayed in the thumbnail form. When the MENU setting operation section 39 is pressed after the shooting/reproduction switching operation section 37 is turned to the reproduction mode, the vertical/horizontal image selection menu 65 is displayed on the display section 55. As shown in FIG. 10, the vertical/horizontal image selection menu 65 is constituted of a horizontal image selection button 65a, and a vertical image selection button 65b. The photographer selects either of the selection buttons, whereby only the horizontal thumbnail images or only the vertical thumbnail images may be displayed on the display section 55.

In FIG. 10, when the horizontal image selection button 65a is selected, the microcomputer 3 and the image display control section 13 extract only images in the horizontal attitude image folder 93a which is created in a hierarchy under the shot image folder 90, and display the horizontal thumbnail images on the display section 55 in order of extraction. As a result, as shown in FIG. 11A, only the horizontal thumbnail images are displayed on the display section 55.

On the other hand, when the vertical image selection button 65b is selected, the microcomputer 3 and the image display control section 13 extract images shot in the vertical shooting attitude in the vertical attitude image folder 94a which is created in the hierarchy under the shot image folder 90, and display the vertical thumbnail images on the display section 55 in order of extraction. In this case, the image display control section 13 causes images to be displayed on the display section 55, the images each having a display region which is selected from the vertical image display region selection menu 66. For example, as shown in FIG. 11B, in the case where the upper region selection button 66b is selected from the vertical image display region selection menu 66, the image display control section 13 enlarges upper region of the vertically shot images and causes the enlarged images to be displayed on the display section 55 in the thumbnail form. Further, for example, as shown in FIG. 11C, in the case where the whole region selection button 66a is selected, thumbnail images of the vertically shot images, each having the whole region, are displayed.

In this manner, the digital camera 1 stores respective shot images into folders which are divided in accordance with the shooting attitude. Accordingly, only the horizontally shot images or only the vertically shot images can be easily extracted, and only thumbnail images having a common shooting attitude can be displayed on the display section 55. Further, in the case of displaying the vertically shot images, images of regions selected from the whole regions of the respective vertical images, are displayed, whereby it is possible to display the vertically shot images, each in an enlarged manner, compared with a case of displaying the vertical images each having the whole region. Accordingly, even in the case of the vertically shot images, it is possible to perform a convenient image display which enables the easy image recognition, in the same manner as the horizontally shot images.

As above described, the digital camera according to embodiment 1 includes the attitude detection section 43, and records the attitude determination signal corresponding to the attitude together with the shot image. Therefore, separate recording in accordance with the shooting attitude may be available.

Further, the digital camera according to the present embodiment has the vertical image display region selection menu, and causes an image having a partial region, among the whole region of the vertical image, to be displayed, whereby it is possible to perform an enlarged display compared with a case of displaying the vertical image having the whole region. Accordingly, it is possible to perform the convenient thumbnail image display which enables the easy image recognition. Further, since the vertical/horizontal image selection section is provided, the shot images can be extracted in accordance with the shooting attitude, and only shot images whose shooting attitudes are identical to one another can be displayed on the display section. Accordingly, the vertical images and the horizontal images are not mixed together, the convenient thumbnail display can be provided to the photographer.

In the present embodiment, the vertical image display region selection menu is constituted of the whole region selection button, the upper region selection button, the central region selection button, and the lower region selection button, but is not limited thereto. The vertical image display region selection menu may be constituted of a plurality of hierarchies. That is, the vertical image display region selection menu may have a hierarchal structure which is constituted of the whole region display selection button and a partial display selection button which is then constituted of the upper, the central, and the lower regions each selectable when the partial display selection button is selected. Accordingly, a menu display can be simplified, and a digital camera which is easy to use and highly convenient to the photographer can be provided.

The present embodiment is exemplified by the digital camera having the image blurring compensation mechanism, but is not limited thereto. A similar effect may be attained from a digital camera without having the image blurring compensation mechanism.

In the present embodiment, the regions selectable from the vertical image display region selection menu 66 are the whole region, the upper region, the central region, and the lower region, but are not limited thereto. Two or more buttons for selecting arbitrary image display regions may substitute therefor, and any other region may be regarded as the display region.

### Embodiment 2

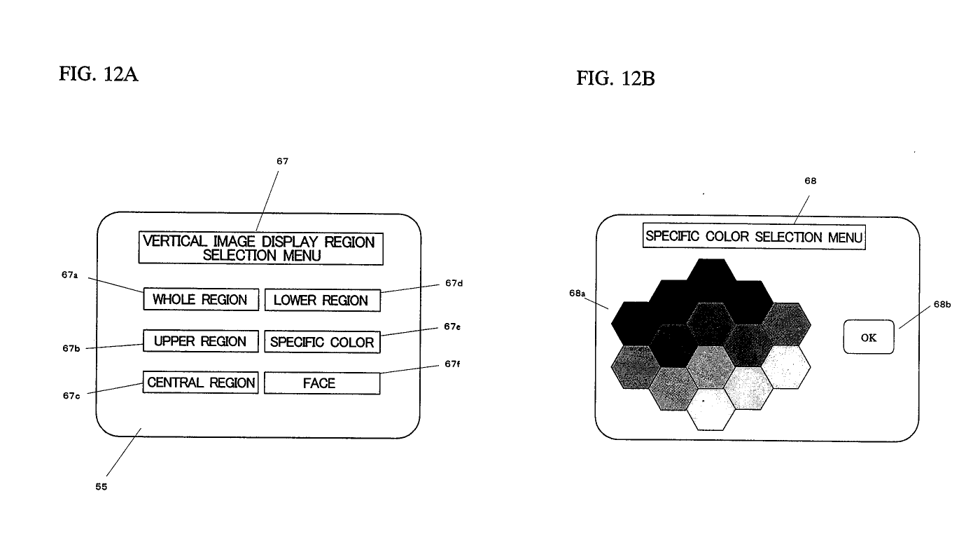

FIGS. 12A and 12B each shows a menu screen displayed on a display section included in a digital camera according to embodiment 2. The digital camera according to the present embodiment has approximately the same configuration as the digital camera according to embodiment 1, but is different in terms of the following points. The digital camera according to the present embodiment is different in that the same has a recognition processing section for recognizing attributes of pixels constituting a shot image. Therefore, the digital camera according to the present embodiment is different in that it is possible to display an image of a region, among the whole region of the vertical image, having predetermined attributes. Hereinafter, only points which are different from embodiment 1 will be described.

FIG. 12A shows a vertical image display region selection menu 67 displayed on a display section 55. In the same manner as embodiment 1, a photographer can select a display region, among the whole region of the vertical image, from the vertical image display region selection menu. The vertical image display region selection menu 67 further includes a specific color selection button 67e and a face selection button 67f, in addition to the whole region selection button 67a, the upper region selection button 67b, the central region selection button 67c and the lower region selection button 67d. The photographer presses any one of the selection buttons in the vertical image display region selection menu, thereby previously selecting the display region among the whole region of the vertical image.

Next, a display process for displaying an image of a region, among the whole region of the vertical image, having the predetermined attributes will be described. Here, the attributes include a hue, saturation, brightness, luminance, gradation and the like. In the present embodiment, an image having a region which centers on a specific color or a human face may be displayed. FIG. 12B is a diagram showing a specific color selection menu 68 displayed on the display section 55. When a specific color selection button 67e is selected, the image display control section 13 causes the specific color selection menu 68 to be displayed on the display section 55. The specific color selection menu 68 includes a color list 68a including a plurality of different colors, and a selection determination button (an OK button) 68b for setting a selected color as the specific color. A user operates across operation key shown in FIG. 2, thereby selecting an arbitrary color from the color list 68a. In this case, in addition to the colors previously set, an arbitrary color which is extracted from a shot image in the past or a color which is set by a photographer may be registered to the color list 68a, and the registered color may be selected as the specific color.

When the specific color selection button 67e is selected from the vertical image display region selection menu 67, a color recognition section extracts, from data of a shot image, a color which is the same as or the most similar to the color previously selected (specific color). A digital signal processing section 8 shown in FIG. 1 then calculates the barycenter of the region including the extracted color with respect to the whole region of the shot image. Further, the image display control section 13 causes an image having a region which centers on the calculated barycenter, among the whole region of the vertical image, to be displayed on the display section 55. Therefore, the image displayed on the display section 55 may be enlarged compared with the case where the whole region of the vertical image is displayed, and thus excels in viewability.

On the other hand, when the face selection button 67f is selected from the vertical image display region selection menu 67, a face recognition section extracts, from the data of the shot image, a region constituted of a human face. The digital signal processing section 8 then calculates the barycenter of the region constituted of the face with respect to the whole region of the shot image. The image display control section 13 causes the region which centers on the calculated barycenter, among the whole region of the vertical image, to be displayed. Therefore, an image displayed on the display section 55 may be enlarged compared with the case where the whole region of the vertical image is displayed, and thus excels in viewability. Note that in the case where there is one face, the image display control section 13 calculates the barycenter of the face, and in the case where there is a plurality of faces, the barycenter of a distribution of the faces is calculated, whereby images each having a region which centers on the barycenter are displayed in an enlarged manner.

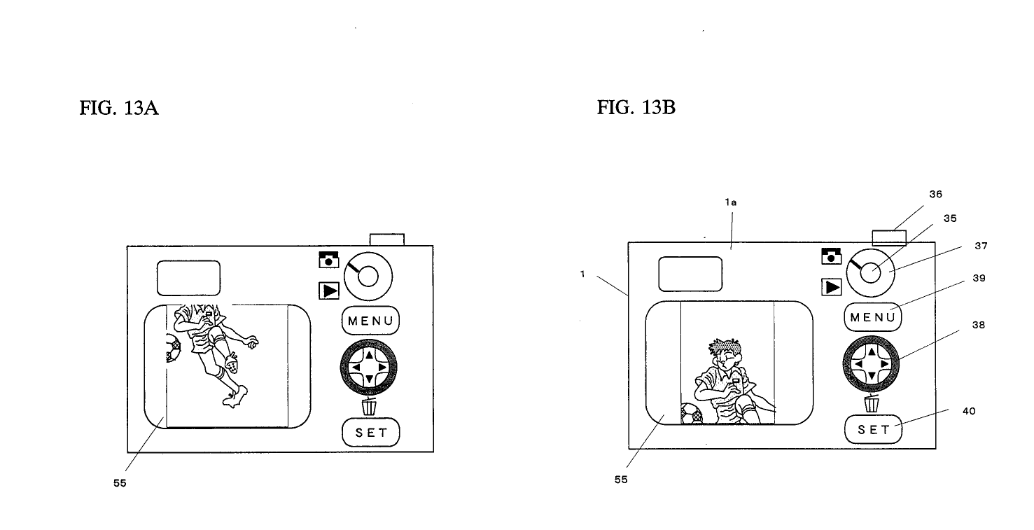

FIG. 13A shows a display section in the case where the specific color selection button 67e is selected from the vertical image display region selection menu 67 in order to display a vertical image shown in FIG. 7B. Here, a color of socks worn by a human in the drawing is set as the specific color. As shown in FIG. 13A, when the specific color selection button 67e is selected, the color recognition section extracts a color, which is the same as or the most similar to the specific color, from data of a shot image, and then calculates the barycenter of the region covered by the extracted color (the color of the socks worn by the human in the drawing). The image display control section 13 causes an image having the region which centers on the calculated barycenter, among the whole region of vertical image, to be displayed.

FIG. 13B is shows a display section in the case where the face selection button 67f is selected from the vertical image display region selection menu 67 in order to display the vertical image shown in FIG. 7B. As shown in FIG. 13B, when the face selection button 67f is selected, the image display control section 13 causes an image having a region which centers on a face of the human included in the shot image to be displayed on the display section 55. Although FIG. 13 shows a case where one reduced image is displayed on the display section 55, a similar display process can be performed in the present embodiment even in the case of displaying thumbnail images.

As above described, the digital camera according to the present embodiment is capable of displaying, in an enlarged manner, the image having the region which includes the predetermined attributes such as the specific color, face and a surrounding thereof, and the like in the shot image. Therefore, a convenient reduced image display or thumbnail image display which enables easy image recognition may be realized.

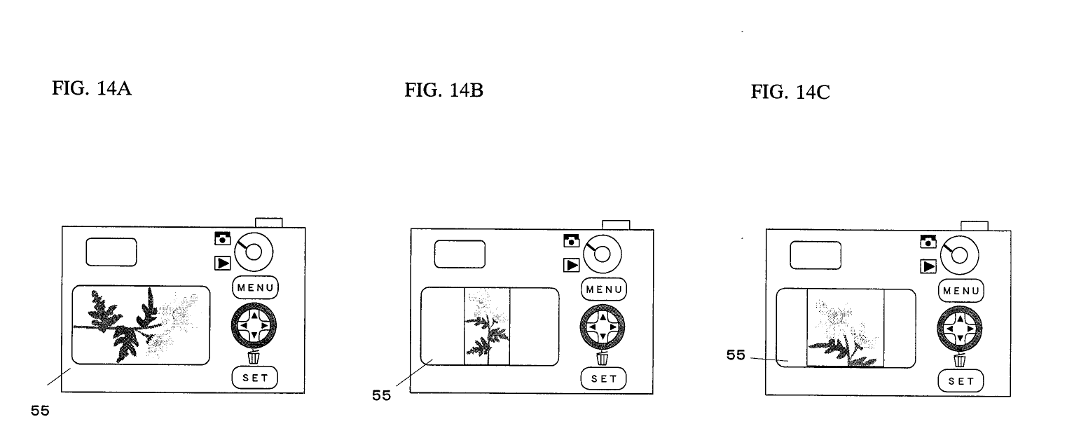

In embodiments 1 and 2, the aspect ratio of each of the horizontally shot image and the display section 55 is 4:3, but is not limited thereto. Even in the case where the aspect ratio of each of the horizontally shot image and the display section 55 is 16:9, as shown in FIGS. 14A to 14C, a similar effect may be obtained. FIG. 14A shows a case where the vertically shot image is displayed on the display section without the attitude thereof having been restored, and FIG. 14B shows a case where the whole region of the vertically shot image is displayed with the attitude thereof having been restored. Further, FIG. 14C shows a case where a color of petals in the vertically shot image is set as the specific color, and the petals and a surrounding thereof are displayed in an enlarged manner. In this manner, even in the case where the aspect ratio of each of the shot image and the display section is 16:9, easily viewable reduced image may be displayed in a similar manner. Further, without limiting to the aspect ratio of 16:9, a similar effect may be obtained from an arbitrary aspect ratio. Specifically, the more a difference between a length of a long side and a length of a shot side of the shot image increases, the more a reduction ratio of the shot image needs to be increased so as to display the whole region of the shot image on the display section. Accordingly, the photographer has difficulty in recognizing the reduced image. Therefore, it is confirmable that, in the case where a shot image having the above-described aspect ratio is displayed, the display methods described in embodiments 1 and 2 are effective.

### Embodiment 3

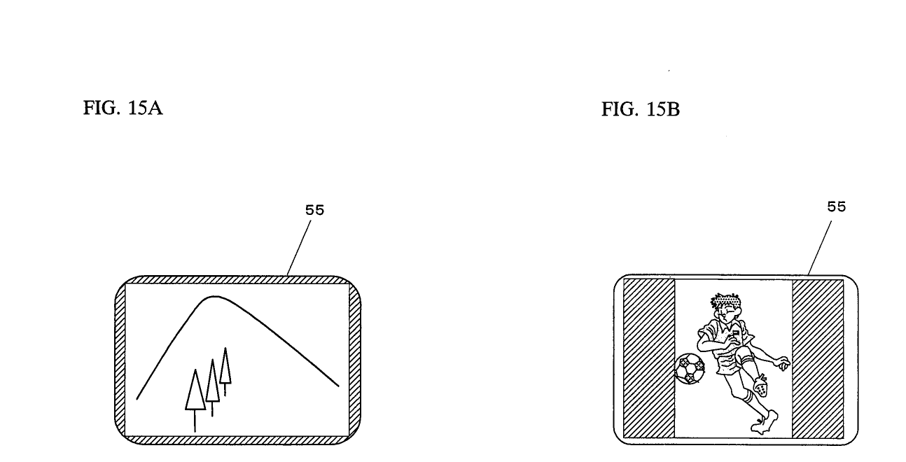

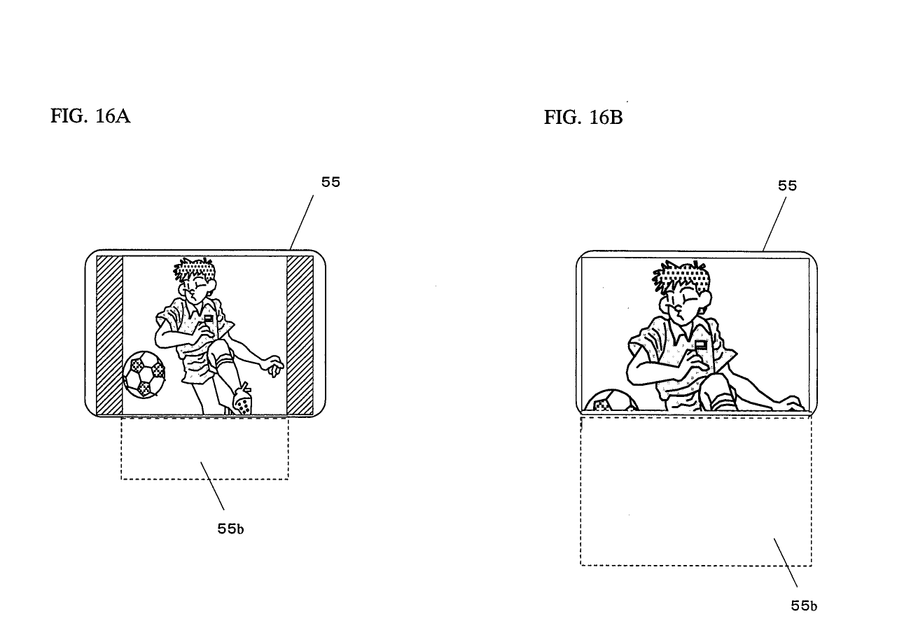

FIGS. 15A, 15B, 16A, and 16B each shows an example of the display of a display section 55, having a shot image displayed thereon, in a digital camera according to embodiment 3. The digital camera according to the present embodiment has approximately the same configuration as embodiments 1 and 2, but is different from the same in terms of being capable of changing a reduction ratio of a shot image to be displayed on the display section and to display an image of a selected region in a further enlarged manner. Hereinafter, differences between embodiments 1 and 2 will be described.

FIG. 15A is a diagram showing an example of the display of the display section 55 in the case where a horizontal image is displayed in a reduced manner. FIG. 15B is a diagram showing an example of the display of the display section 55 in the case where a vertical image is displayed in a reduced manner. In the present embodiment, an aspect ratio of each of the horizontal image and the display section 55 is 4:3. Therefore, as shown in FIG. 15A, in the case where the whole region of the horizontal image is displayed on the display section 55, a digital camera 1 can perform displaying while minimizing margins (diagonally shaded regions in the drawing) of the display section 55. On the other hand, as shown in FIG. 15B, in the case where the whole region of the vertical image is displayed on the display section 55, the aspect ratios of the vertical image and the display section are different from each other, and thus the image needs to be reduced such that a vertical height of the vertical image is equal to or smaller than the a vertical height of the display section. Therefore, the vertical image is displayed in a small size compared with the horizontal image, and thus there may be a case where the photographer has difficulty in recognizing the image. Therefore, the digital camera according to the present embodiment is capable of changing the reduction ratio of a horizontal width of the vertical image with limits of the horizontal width of the display section and of adjusting a size of the reduced image to be displayed on the display section.

FIGS. 16A and 16B each shows an example of the display of the display section 55 in the case where the vertical image is displayed in a reduced manner in the digital camera according to the present embodiment. The aspect ratio of each of the shot image and the display section 55 is 4:3. A region 55b in the drawing represents a region, among the whole region of the vertical image, which is not displayed on the display section 55. As shown in FIG. 16, the digital camera according to the present embodiment is capable of arbitrarily adjusting the horizontal width of the vertical image to be displayed on the display section 55 with limits of the horizontal width of the display section 55 (FIG. 16B). That is, the reduction ratio is changed in accordance with the shot image, whereby the size of the image to be displayed can be adjusted. Note that since the vertical height of the vertically shot image is greater than the vertical height of the display section 55, a partial region (55b in the drawing) of the vertically shot image is not displayed.

As above described, the digital camera according to the present embodiment is capable of adjusting the reduction ratio of the image to be displayed on the display section. Accordingly, it is possible to enlarge an area of the reduced image to be displayed on the display section, and to effectively utilize an available display region. Therefore, the photographer can display an image having a region desired to be confirmed specifically, and also a display in the same size as the horizontal shooting shot image or in a larger size than the horizontal shooting shot image can be performed compared with the case where the whole region of the vertical image is displayed, which consequently leads to the easy image recognition and superior viewability.

Even in the case where the aspect ratio is 16:9 or the like, as long as a part of a vertically shot image having the same size as a horizontally shot reduced image is displayed, or as long as the vertically shot image is displayed by equalizing the horizontal width thereof and the horizontal width of the display section 55, a display process exerting the same effect as that above described may be performed.

In embodiments 1 to 3, the thumbnail images each in a horizontally shot image size, which are shown in respective drawings, are not limited to the horizontally shot images, but may be vertical thumbnail images with partial regions thereof each being displayed in an enlarged manner.

### Embodiment 4

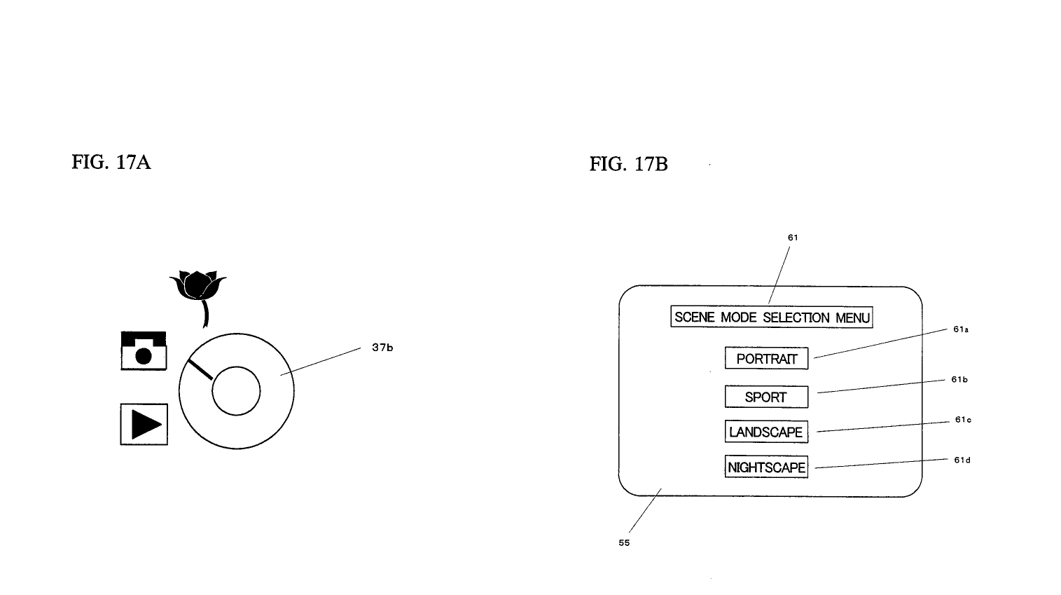

FIG. 17A shows a shooting/reproduction switching operation section included in a digital camera according to embodiment 4, and FIG. 17B is a diagram showing a scene mode selection menu 61 displayed on a display section. The digital camera according to the present embodiment has approximately the same configuration as embodiments 1 to 3, but is different in terms of having a shooting mode setting section and a scene mode setting section provided thereto. In the digital camera according to the present embodiment, an image having an upper region, among the whole region of a vertical image, is particularly displayed on the display section.

In FIG. 17A, in addition to a shooting mode and a reproduction mode, a shooting/reproduction switching operation section 37b includes a macro shooting mode (a flower symbol in the drawing). Here, the macro mode enables a shooting close to an object, and is performed in the case where a small object or a part of an object is shot widely.

Further, FIG. 17B shows a scene mode selection menu 61 at the time of shooting, and scene modes includes, for example, a portrait mode 61a, a sport mode 61b, a landscape mode 61c, a nightscape mode 61d and the like. A photographer can select an appropriate scene mode from the selection menu 61 in accordance with a scene to be shot. Normally, it is often the case that a shooting in a vertical shooting attitude is used in the case where a vertically oriented object such as a building and a human is shot. Further, it is often the case that in the case of shooting in the vertical shooting attitude, focusing is set at or above a central part of a screen. Therefore, in the case where the shooting mode and the scene mode, each in which an upper region of a vertically shot image is more likely to be confirmed, are selected, the digital camera according to the present embodiment causes the upper region of the vertical image to be displayed on the display section 55. Specifically, in the case where a vertical image has been shot in the portrait mode 61a or the landscape mode 61c of the normal shooting mode (except for the macro shooting mode) in accordance with the selection from the scene mode selection menu 61, the upper region of the shot image is displayed on the display section 55. Accordingly, the photographer need not previously set a region desired to be displayed, among the whole region of the vertical image, and thus a workload of the photographer can be reduced.

As above described, in the case of confirming the vertical image, with the use of the digital camera according to the present embodiment, a region to be specifically confirmed, among the whole region of the vertical image, is displayed in an enlarged manner, whereby the image can be confirmed easily.

In the present embodiment, a setting mode, in which the upper region of the vertically shot image is more likely to be confirmed, is exemplified by the case of the portrait mode or the scene mode, but is not limited thereto. Even in another setting mode, if the upper region of the vertically shot image is more likely to be confirmed, then the upper region of the vertical image may be displayed on the display section.

Embodiments 1 to 4 are exemplified by the digital cameras each having the imaging optical system, but are not limited thereto. For example, a digital camera of a single-lens reflex type whose lens is exchangeable may also attain a similar effect.

### Embodiment 5

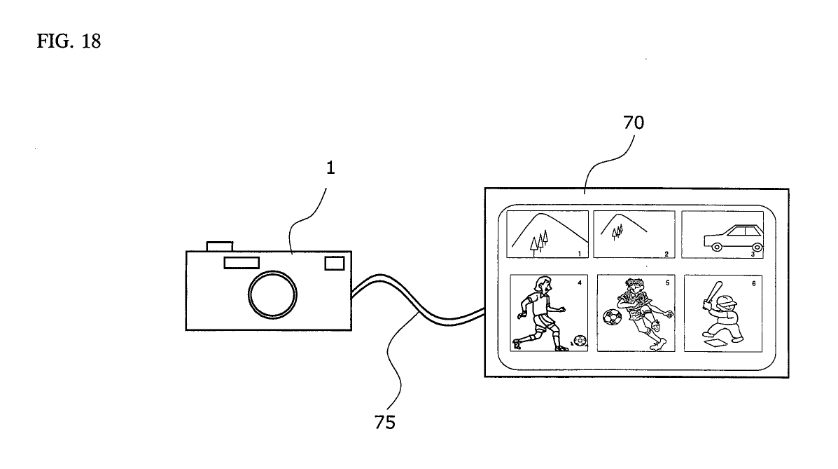

FIG. 18 shows a digital camera and a display device according to embodiment 5. The digital camera according to the present embodiment has approximately the same configuration as embodiments 1 to 4, but is different in that a shot image and a reduced image are displayed on an external display device, which is connected to an imaging device, in accordance with attitude information at the time of shooting. As shown in FIG. 18, shot images recorded in an image recording section of the digital camera 1 together with the attitude information are displayed on a display device 70 such as a TV monitor via a cable 75. As the cable 75, a USB (Universal Serial Bus) cable may be used, for example. Since images displayed on the display device 70 are controlled by an image display control section 13 of the digital camera 1, in the same manner as embodiments 1 to 3, it is possible to display images each restored so as to be in an attitude at the time of the shooting and thumbnail images thereof on the external display device.

Based on the above-described configuration, in the case where the display section is not provided to the digital camera, or in the case where a display size of each of shot images is desired to be enlarged, with an operation of the digital camera 1, the images each restored so as to be in the attitude at the time of the shooting can be displayed on an external TV monitor or the like, in the same manner as embodiments 1 to 4. Therefore, it is possible to provide an imaging device and a display device which are highly convenient and enable easily viewable and convenient thumbnail display.

In the present embodiment, the external display device is exemplified by the TV monitor, but is not limited thereto. For example, there may be available a configuration in which a personal computer having a monitor connected thereto is connected via a cable.

In the present embodiment, the cable 75 is exemplified by the USB cable, but is not limited thereto. For example, connection may be performed by using an IEEE1394 serial bus cable or wirelessly by using a wireless LAN or the like.

### Embodiment 6

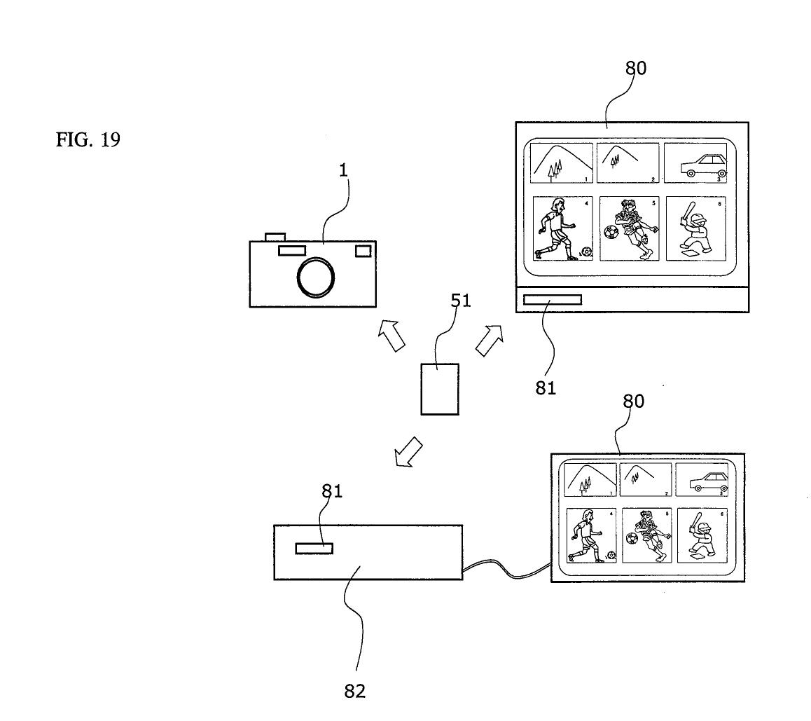

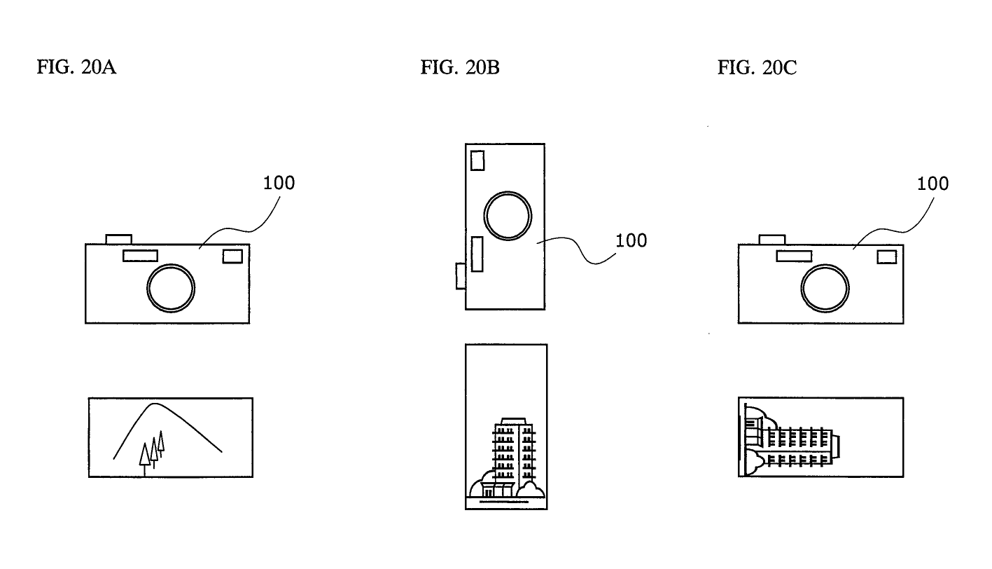

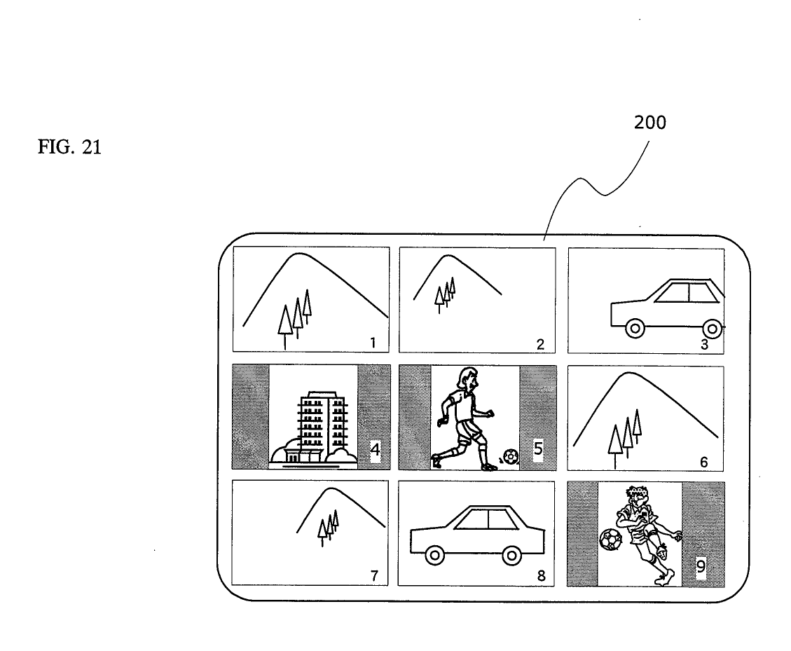

FIG. 19 shows a display control device according to embodiment 6. A digital camera according to the present embodiment has approximately the same configuration as embodiments 1 to 5, but is different in that display control by each of the digital cameras in embodiments 1 to 4 is performed by the display control device 82, that is, for example, a personal computer having image processing software therein, a monitor and the like. Images shot by a digital camera 1 are each recorded, together with a reduced image and attitude information, in a removable memory 51 such as a detachable memory card. The removable memory 51 is not limited to the memory card, but may be a hard disk, an optical disc and the like. The shot images are displayed on a display device 80 having included therein a removable memory insertion section 81, which is capable of reading the removable memory 51, and a display control device. Images displayed on the display device are each display-controlled by the display control device in accordance with the attitude information recorded in the removable memory 51, in the same manner as embodiments 1 to 3.

Based on the above-described configuration, the display control device 82 according to the present embodiment reads the shot images obtained by the digital camera 1, the reduced image, and the attitude information from the removable memory 51 having all of the same recorded therein, whereby images, which are each restored so as to be in an attitude at the time of shooting in accordance with the attitude information, and thumbnail images thereof are displayed on the display device, as described in embodiments 1 to 3.

The display device including the display control device is exemplified by the personal computer, but is not limited thereto. For example, as shown in FIG. 19, display may be performed on the TV monitor via a hard disk recorder, a DVD recorder or the like which is capable of reading the removable memory 51.

The present embodiment is exemplified by the display device including the removable memory insertion section 81 and the display control device, but is not limited thereto. For example, there may be available a configuration in which a reading device such as a memory card reader which is capable of reading the removable memory 51, the display control device, and the display device are connected to one another.

In embodiments 1 to 6, the imaging devices each including one shutter operation section are used, but are not limited thereto. For example, a shutter operation section for shooting in the horizontal shooting attitude, and a shutter operation section shooting in the vertical shooting attitude may be individually mounted, and the shooting attitude may be determined by using the shutter operation sections.

In embodiments 1 to 6, the shot images are exemplified by still images. However, even in the case where moving images, simplified moving images or the like are shot, a similar effect can be attained.

In embodiments 1 to 6, with respect to the shooting attitude, the horizontal shooting attitude is set as 0 degree and an attitude which is rotated about the optical axis by 90 degrees is regarded as the vertical shooting attitude. However, a similar effect may be attained in the case of an attitude which is rotated by −90 degrees. Further, the attitude determination signal for the attitude which is rotated by −90 degrees is set to (2), whereby it may be possible to detect total of three types of attitudes, i.e., one type of the horizontal attitude and two types of the vertical attitudes.

In each of embodiments 1 to 6, a method is exemplified by a method for adding the signal of (0) or (1) as the attitude determination signal, but is not limited thereto. For example, a method for adding a signal only to the vertical shooting attitude may be adopted. Further, without limiting to a method in which the attitude determination signal is recorded in the shot image, a method may be adopted, in which the attitude determination signal 61 is recorded in a file different from the shot image, and the shot image and the file having the attitude determination signal 61 recorded therein are interrelated with each other.

Embodiments 4 and 5 are each exemplified by a case where the shot image is displayed on the external display device, but are not limited thereto. For example, a configuration in which connection is performed with respect to printing means such as a printer may also attain a similar effect.

In embodiments 1 to 6, the aspect ratio of each of the display sections is set 4:3, 16:9, and the like such that the horizontal width is set as the long side, but is not limited thereto. A display section, in which the vertical height is set as the long side, may also attain a similar effect.

### INDUSTRIAL APPLICABILITY

An imaging device, a display control device, and a display device of the present invention are applicable to a digital still camera, a digital video camera, a cellular phone and a PDA each having a camera equipped therewith, a DVD recorder, a hard disk recorder and the like which are all requested to have a convenient display in relation to a display method of a shot image.

1. An imaging device for outputting an optical image of an object as an electrical image signal, the imaging device comprising:
a display section for displaying an image in accordance with the image signal;
an imaging optical system for forming the optical image of the object;
an imaging section for receiving the optical image formed by the imaging optical system and converting the optical image into the electrical image signal;
an attitude detection section for detecting an attitude of the imaging device at the time of shooting;
a recording section for recording a shot image obtained by the imaging section, and attitude information about the attitude of the imaging device, the attitude being detected by the attitude detection section and corresponding to the shot image; and
an image display control section for restoring the shot image, in accordance with the attitude information, such that an orientation thereof corresponds to the attitude of the imaging device at the time of the shooting, clipping a portion of a reduced image of the restored shot image, and displaying the clipped image on the display section.

2. An imaging device for outputting an optical image of an object as an electrical image signal, the optical image being formed by an exchangeable imaging optical system, the imaging device comprising:
a display section for displaying an image in accordance with the image signal;
an imaging section for receiving the optical image formed by the imaging optical system which is mounted, and converting the optical image into the electrical image signal;
an attitude detection section for detecting an attitude of the imaging device at the time of shooting;
a recording section for recording a shot image obtained by the imaging section, and attitude information about the attitude of the imaging device, the attitude being detected by the attitude detection section and corresponding to the shot image; and
an image display control section for restoring the shot image, in accordance with the attitude information, such that an orientation thereof corresponds to the attitude of the imaging device at the time of the shooting, clipping a portion of a reduced image of the restored shot image, and causing the clipped image to be displayed on the display section.

3. The imaging device according to claim 1, further comprising,
an image extraction section for extracting, from the shot images recorded in the recording section, a shot image whose aspect ratio after the restoring is different from an aspect ratio of the display section, wherein
the image display control section restores the extracted shot image, in accordance with the attitude information, such that an orientation of the shot image corresponds to the attitude of the imaging device at the time of the shooting, clips a portion of a reduced image of the restored shot image, and causes the clipped image to be displayed on the display section.

4. The imaging device according to claim 1, further comprising
an image extraction section for extracting, from the shot images recorded in the recording section, shot images having common attitude information or a common aspect ratio, wherein
the image display control section restores the extracted shot image, in accordance with the attitude information, such that an orientation of the shot image corresponds to the attitude of the imaging device at the time of the shooting, clips a portion of a reduced image of the restored shot image, and causes the clipped image to be displayed on the display section.

5. The imaging device according to claim 1, wherein the image display control section displays, on the display section, the clipped image whose center position is different from that of the shot image recorded in the recording section.

6. The imaging device according to claim 1, further comprising
a reduction ratio setting section for setting a reduction ratio of the shot image, wherein
the image display control section clips a portion of a reduced image which is obtained by reducing, at the set reduction ratio, the shot image after the restoring, and causes the clipped image to be displayed on the display section.

7. The imaging device according to claim 1, further comprising
a reduction ratio setting section for setting a reduction ratio of the shot image such that a length of a short side of the shot image after the restoring and a length of a long side of the display section become approximately equal to each other, wherein
the image display control section clips a portion of a reduced image which is obtained by reducing, at the set reduction ratio, the shot image after the restoring, and causes the clipped image to be displayed on the display section.

8. The imaging device according to claim 1, further comprising
a region selection section for selecting and setting a partial region from a reduced image of the shot image, wherein
the image display control section clips the selected region from the reduced image of the restored shot image, and causes the clipped image to be displayed on the display section.

9. The imaging device according to claim 1, further comprising:
a region selection section for selecting and setting a partial region from a reduced region of the shot image; and
a vertical image extraction section for extracting a shot image having vertical direction information in accordance with attitude information recorded in the recording section, wherein
the region selection section is operable to select any one of an upper region, a central region, and a lower region of the shot image extracted by the image extraction section.

10. The imaging device according to claim 1, further comprising:
an image attribute recognition section for recognizing an attribute which is included in the shot image recorded in the recording section; and
a region selection section for selecting and setting a region including the recognized attribute from a reduced image of the shot image, wherein
the image display control section clips the selected region from the reduced image of the restored shot image, and causes the clipped image to be displayed on the display section.

11. The imaging device according to claim 1, further comprising:
a color recognition section for recognizing a specific color from the shot image recorded in the recording section; and
a region selection section for selecting and setting a region including the recognized specific color from a reduced image of the shot image, wherein
the image display control section clips the selected region from the reduced image of the restored shot image, and causes the clipped image to be displayed on the display section.

12. The imaging device according to claim 1, further comprising:
a face recognition section for recognizing a face region of the object from the shot image recorded in the recording section; and
a region selection section for selecting and setting the recognized face region from a reduced image of the shot image, wherein
the image display control section clips the selected region from the reduced image of the restored shot image, and causes the clipped image to be displayed on the display section.

13. The imaging device according to claim 1, further comprising:
a vertical image extraction section for extracting a shot image having vertical direction information in accordance with the attitude information recorded in the recording section, wherein
the image display control section reduces the shot image such that a length of a short side of the extracted shot image and a length of a long side of the display section become approximately equal to each other, clips a region including an upper end of the reduced image, and causes the clipped image to be displayed on the display section.

14. An imaging device operable to output an optical image of an object as an electrical image signal and to be connected to a display section, the imaging device comprising:
an imaging optical system for forming the optical image of the object;
an imaging section for receiving the optical image formed by the imaging optical system and converting the optical image into the electrical image signal;
an attitude detection section for detecting an attitude of the imaging device at the time of shooting;
a recording section for recording a shot image obtained by the imaging section, and attitude information about the attitude of the imaging device, the attitude being detected by the attitude detection section and corresponding to the shot image;
an image display control section for generating a control signal which controls a display of the shot image recorded in the recording section; and
an output section for providing the generated control signal and the shot image to the display section, wherein
the control signal includes a signal which causes the shot image to be restored in accordance with the attitude information such that an orientation thereof corresponds to the attitude of the imaging device at the time of the shooting, causes a portion of a reduced image of the restored shot image to be clipped, and causes the clipped image to be displayed on the display section.

15. A display control device connectable to a display section, the display control device comprising:
a reading section for reading a shot image and attitude information which are recorded in a recording section, the attitude information indicating an attitude of an imaging device and corresponding to the shot image;
an image display control section for generating a control signal causing a reduced image of the shot image to be displayed; and
an output section for providing the shot image and the attitude information, which have been read, to the display section, wherein
the control signal includes a signal which causes the shot image to be restored in accordance with the attitude information such that an orientation thereof corresponds to the attitude of the imaging device at the time of shooting, causes a portion of a reduced image of the restored shot image to be clipped, and causes the clipped image to be displayed on the display section.

16. The display control device according to claim 15, further comprising:
an image extraction section for extracting, from the shot images recorded in the recording section, shot images having common attitude information or a common aspect ratio, wherein
the control signal includes a signal which causes the extracted shot image to be restored in accordance with the attitude information such that an orientation thereof corresponds to the attitude of the imaging device at the time of shooting, causes a portion of a reduced image of the restored shot image to be clipped, and causes the clipped image to be displayed on the display section.

17. The imaging device according to claim 14, wherein the control signal includes a signal which is operable to control a number of display sheets of the clipped image.
